(19) United States
(12) Patent Application Publication
(10) Pub. No.: US 2025/0277650 A1
(43) Pub. Date: Sep. 4, 2025

(54) Miniaturized Guide Rod Camera System

(71) Applicant: Arthur Thomas Bradley, Williamsburg, VA (US)

(72) Inventor: Arthur Thomas Bradley, Williamsburg, VA (US)

(21) Appl. No.: 18/623,002

(22) Filed: Mar. 31, 2024

Related U.S. Application Data
(60) Provisional application No. 63/561,171, filed on Mar. 4, 2024.

(51) Int. Cl. F41G 3/16; F41C 27/00; H04N 23/57

(52) U.S. Cl. CPC F41G 3/165; F41C 27/00; H04N 23/57

(57) ABSTRACT

The present invention is a camera system partially or fully embedded into the guide rod of a handgun. Being hollow, non-moving, and aligned with the barrel, the guide rod is an ideal location for an embedded camera system that looks in a direction that the muzzle of the firearm is facing. The apparatus may include a lens, camera, image capture and processing electronics, controller, communications interface, data storage unit, activation switch, and battery unit. Video is saved to an internal data storage unit. Data is retrieved either by removing the memory storage device or by transferring it via a wired or wireless communications interface. By capturing first-person video, the invention creates a visual record of the situation in which the firearm was used.

### CROSS-REFERENCE TO RELATED APPLICATIONS

This application claims the benefit of U.S. provisional patent application No. 63/561,171 filed on Mar. 4, 2024 and titled “Miniaturized Guide Rod Camera System,” the content of which is incorporated by reference in its entirety.

### BACKGROUND

### Field of the Invention

The present invention relates generally to firearm accessories, and in particular to a miniaturized camera system largely or completely embedded into a housing that operably acts as the guide rod for an automatic or semi-automatic handgun. Semi-automatic and automatic handguns almost universally use a guide rod assembly to manage recoil by guiding movement of the slide both during firing and as it subsequently returns forward to the ready position. The assembly is made up of a guide rod surrounded by one or more recoil springs. As the handgun's slide moves rearward, the recoil spring compresses, thus helping to reduce recoil. Once the energy is absorbed, the recoil spring expands, pushing the slide back to the fully-closed position (aka back into battery). The guide rod is generally centered in the recoil spring and helps to keep the recoil spring from kinking, binding, or twisting during operation. Additionally, the guide rod helps to ensure proper alignment of the barrel and slide assembly.

### Scope of the Prior Art

The present invention records real-time video from a first-person perspective, that is from the perspective of the firearm operator. Note that in this disclosure, the term video refers to both moving video and still images. The video would serve as an indisputable first-person account of the situation leading up to the use of the firearm. As such, it would be valuable in determining if brandishing or discharge of the firearm was justified within the limits of the law. Additionally, if criminal or civil complaints were filed, the video recording could provide vital evidence to both the defense and prosecution in determining liability. Additionally, real-time, first-person video recordings could be helpful in training programs that focused on the proper use of firearms, such as those for police officers, security guards, and military personnel.

Existing firearm cameras are attached externally to the firearm's frame due to the camera system's large size and elevated power requirements. Such cameras serve the same general function as the one proposed here but suffer from several disadvantages. First, they generally require that the firearm feature a built-in mounting system, such as a rail. Second, the attachment of an externally-mounted camera system changes the firearm's profile, thus preventing or limiting the use of standard holsters and cases. Third, the externally-mounted camera system adds significant weight and size to the firearm, potentially negatively affecting its handling. Fourth, externally-mounted camera systems are prone to being damaged and knocked out of alignment. Fifth, externally-mounted cameras are generally power inefficient and require the frequent replacement of batteries. Finally, existing firearm-mounted cameras generally require manual activation, making them difficult to use quickly when the operator is in a heightened stress situation.

The present invention eliminates, or at least greatly alleviates, these disadvantages in semi-automatic or automatic handguns by miniaturizing the camera system and largely or completely embedding it within an enclosure that operably functions as the handgun's guide rod. This is made possible in part because modern charge coupled device (CCD) and complementary metal oxide semiconductor (CMOS) imaging sensors, microcontrollers, data storage devices, and interfaces have become small enough to allow embedding them into applications previously considered impossible.

The camera and camera lens are mounted at or near the muzzle-end of a hollow housing that operably acts as the handgun's guide rod. The camera can be partially or fully contained within the housing, affixed to the end of the housing, or simply positioned near one end of the housing. The lens is operatively coupled to the camera, facing in a direction approximately parallel to the barrel (i.e., out the front of the handgun and toward the target). The remainder of the camera system, including the controller with its associated program memory, battery unit, data storage unit, power management circuitry, and any communications interfaces, if present, are enclosed in the housing. Additionally, the camera system's activation switch, if it has one, may be completely contained within the guide rod, such as when using a gravity switch (aka tilt switch or orientation-controlled switch), light sensor (e.g., photodiode, photoresistor, or other photosensitive device), or remotely-controlled relay, or it may be incorporated elsewhere in the firearm, such as in the firearm's grip, backstrap, magazine release, safety, trigger, slide stop lever, or take down lever. The embedded camera system does not require a rail system to mount and could be easily installed into nearly any modern semi-automatic or automatic handgun produced by Glock, Heckler and Koch, Sig Sauer, Smith and Wesson, Colt, Walther, and other manufacturers. Since the camera system would be internal and not appreciably affect the handgun's profile, the pistol would fit into holsters and cases already designed for the unmodified firearm. Additionally, the weight and location of the embedded camera system would be comparable to that of a standard factory guide rod and thus would not affect weapon handling. Additionally, since it would be completely embedded within the firearm, the camera system would not easily be damaged or knocked out of alignment. Further, since it would use miniaturized low-power components and optimized power management, battery power consumption could be minimized. While the present invention is discussed primarily herein in context for use in semi-automatic or automatic handguns, the same concept of incorporating an embedded camera system could also be applied to many semi-automatic or automatic rifles and shotguns.

### SUMMARY

The present disclosure satisfies the foregoing needs by providing, inter alia, an integrated camera system for addressing each of the foregoing desirable traits.

When an automatic or semi-automatic handgun is discharged, a firing pin or hammer strikes the cartridge primer, which then ignites the gunpowder, resulting in a small, controlled explosion inside the casing. This propels the bullet away from the casing, along the barrel, and out the muzzle of the firearm. The corresponding opposite reaction propels the slide of the handgun rearwards, ejecting the spent casing. A guide rod assembly, consisting of a guide rod and recoil spring, helps to absorb the recoil and return the slide to its initial position (aka returns it back into battery). A similar process occurs when discharging an automatic or semi-automatic rifle or shotgun.

When the handgun's slide travels rearward, the recoil spring compresses, and when the slide returns forward, the recoil spring relaxes. The guide rod is generally a nonmoving part aligned parallel with the barrel of the firearm. Further, it typically has a hollow interior and is constructed of metal or plastic. Being hollow, non-moving, and aligned with the barrel, the guide rod is an ideal location for an embedded camera system that looks in a direction that the muzzle of the firearm is facing.

The present invention is directed at a camera system integrated into a housing that operably acts as the guide rod for an automatic or semi-automatic handgun. The device records video of the scene directly in front of the firearm's muzzle. The camera can be partially or fully contained within the housing, affixed to the end of the housing, or simply positioned near one end of the housing. The lens is operatively coupled to the camera, facing in a direction approximately parallel to the barrel (i.e., out the front of the handgun). The supporting electronics are embedded in the guide rod. The device is powered by a battery unit that is housed within the guide rod. The battery unit may be rechargeable or one-time use. If the battery unit is rechargeable, a charge port may be included in the design. The charge port could be accessible without disassembling the handgun, such as integrated into the grip, backstrap, magazine release, slide stop lever (aka slide release, slide catch lever, or slide stop), or takedown lever. Alternatively, access to the charge port might require that the firearm be partially disassembled, such as if the charge port is located at one end of the guide rod. Alternatively, the charge port could be located internal to the guide rod, accessible by partially disassembling the guide rod or by removing the battery unit. The charge port could be separate from, or combined with, the communications interface, if present.

The housing that operably acts as a guide rod may be flared or enlarged at one or more locations along its length to allow the battery unit, camera, controller with its associated program memory, data storage unit, communications interface, or other electronics to fit within. The guide rod may be a solid unbroken rod or a plurality of interconnected segments. One or both ends may be removable to allow for the camera system to be inserted within. Alternatively, the guide rod may be a clamshell design, enabling the rod to be separated into top and bottom segments for easier insertion of the camera system components. The guide rod may be encircled by a single recoil spring, the spring encompassing either the entire guide rod or just a portion of the guide rod. Alternatively, the guide rod assembly may incorporate a plurality of springs of the same or different diameters to accommodate different diameter segments of the guide rod. One or both ends of the guide rod may be removable to gain access to the camera and electronics. Also, the guide rod may be separable along its length in one or more locations.

The camera system will include a data storage unit to store data (e.g., video, audio, status) for later retrieval, or temporarily buffer data for real-time wireless transmission to an external device, such as a cell phone, computer, or wireless device. The data storage unit may be removable flash memory, such as a micro-SD Card, nano memory (NM) card, or USB-C memory stick (aka flash drive), or it may be memory components soldered to a circuit board, such as static random access memory (SRAM), nonvolatile random access memory (NVRAM) or dynamic random access memory (DRAM) components. Additionally, the data storage unit may be flash memory, such as a micro-SD card or nano memory card, that has been soldered or otherwise permanently affixed to the circuit assembly, making it non-removable. The circuit assembly containing the data storage unit could be removable or fixed in place within the guide rod.

The camera system may have one or more communication interfaces. These could include wired connections, such as universal serial bus (e.g., micro-USB, USB-C, etc.), discrete signaling, or other conventional or custom wired interfaces. Additionally, the camera system may include one or more wireless connections, such as Bluetooth or WiFi. The communications interfaces could be used to retrieve data (e.g., video or audio recordings), check the status of the device, change functionality or settings of the device, program the controller, or charge the batteries. In the case that video is recorded to a removable media, such as a micro-SD Card, the camera system may exclude a communications interface. In such a case, however, the camera system may still have a programming port to upload or change the software in the controller. The camera system will also contain voltage level translators if they are required to interface between the camera, controller, data storage unit, status indicators, communications interface, and other electronics.

In addition to video, the camera system may have audio capabilities. Specifically, it may include one or more microphones that are capable of capturing voice and other sounds in the immediate environment near the firearm. Such audio information could also prove valuable during a subsequent investigation or as part of a training program. The microphone could receive sound through either end of the guide rod, through apertures or opening in the body of the guide rod, or through vibrations in the guide rod itself.

The camera system may also have one or more visual or audible status indicators to show the operability of the device. For example, status indicators could display battery health and charge level, whether the camera is recording, and the amount of memory remaining. Visual status indicators could be at either end of the guide rod, or they could show through one or more holes apertures in the body of the guide rod. The camera system may also have a speaker, beeper, buzzer, or other audible device as part of the status indicators unit.

The camera system will include a controller to perform actions such as reading image data from the camera, processing the image data, including encoding and decoding, writing data to the data storage unit, transferring information to and from the communications interfaces, monitoring the state of charge and health of the battery unit, and controlling status indicators. The controller may be a separate electronic component, such as a microcontroller or field programmable gate array (FPGA), or it may be integrated with the camera, data storage unit, communications interface, or another electronics subsystem housed in the guide rod. While not shown explicitly, the controller may have built-in program memory, or it may retrieve program memory from a separate non-volatile memory component, such as a an electrically erasable programmable read-only memory (EEPROM) or non-volatile static random-access memory (nvSRAM). The camera system will also contain voltage level translators if they are required to interface between the camera, controller, data storage unit, status indicators, communications interface, and other electronics. Additionally, the camera system may have power management circuitry to optimize battery life while still enabling rapid activation of the device.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there are shown in the drawings variations that are presently preferred. It should be understood, however, that the invention is not limited to the precise arrangements shown. In particular, the presently preferred variations show the present invention applied to a semi-automatic handgun, but similar drawings could be generated for automatic handguns, and the same concept of an embedded camera system could be readily applied to semi-automatic or automatic rifles and shotguns. In the drawings, where:

FIG. 1 illustrates prior art of a camera system mounted externally to the rail of a semi-automatic handgun.

FIG. 2 illustrates a simplified block diagram of the present invention.

FIG. 3 illustrates a cutaway view of one embodiment of the present invention.

FIG. 4 illustrates an exploded view of one embodiment of the present invention.

FIG. 5 illustrates a cutaway view of one embodiment of the present invention embedded into a semi-automatic handgun.

FIG. 6 illustrates a cutaway view of one embodiment of the present invention with a rechargeable battery, removable data storage unit, and a wired interface.

FIG. 7 illustrates an exploded view of one embodiment of the present invention with a rechargeable battery, removable data storage unit, and a wired interface.

FIG. 8 illustrates a cutaway view of one embodiment of the present invention with disposable batteries, removable data storage unit, and a wired interface.

FIG. 9 illustrates an exploded view of one embodiment of the present invention with disposable batteries, removable data storage unit, and a wired interface.

FIG. 10 illustrates an exploded view of one embodiment of the present invention with a rechargeable battery, removable data storage unit, and clamshell housing.

FIG. 11 illustrates an exploded view of one embodiment of the present invention with a rechargeable battery, non-removable data storage unit, wired communications interface, and clamshell housing.

FIG. 12 illustrates a cutaway view of one embodiment of the present invention placed in the lower portion of a handgun. Note that for clarity, the guide rod housing and recoil spring are not shown.

FIG. 13 illustrates a cutaway view of one embodiment of the present invention placed in the lower portion of a handgun. In this figure, the guide rod housing and spring assembly are shown for completeness.

FIG. 14 illustrates a cutaway view of a guide rod camera system having a variable diameter housing, according to an embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of an automatic or semi-automatic handgun, it will be recognized by those of ordinary skill that the present disclosure is not so limited. In fact, the principles of the present disclosure described herein may be readily applied to other firearms, such as semi-automatic and automatic rifles and shotguns, as well as other devices in which a miniaturized camera system could be embedded.

In the present specification, an implementation showing a singular device should not be considered limiting; rather, the disclosure is intended to encompass other implementations including a plurality of the same device, and vice-versa, unless explicitly stated otherwise herein. Further, the present disclosure encompasses present and future known equivalents to the devices referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

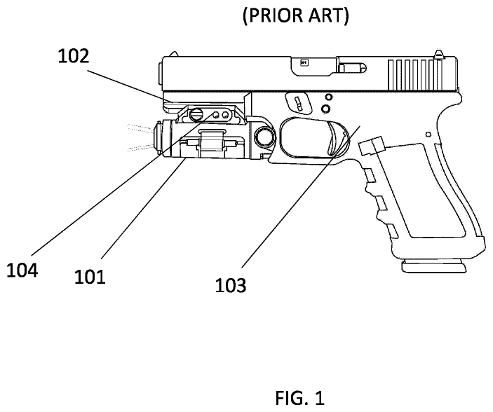

FIG. 1 illustrates prior art of a camera system 101 mounted to the rail 102 of a semi-automatic handgun 103. Due to the camera system's large size and power and interface requirements, it must be mounted externally to the frame via a built-in rail 102. This limits the camera system's functionality in several ways. First, it limits the camera system's use to only those firearms equipped with compatible rails 102. The camera system 101 also significantly changes the handgun's profile, thus preventing the use of standard holsters. Additionally, the camera system 101 adds weight and volume to the front of the handgun, affecting its handling. Due to being externally mounted, the camera system 101 is prone to being damaged and knocked out of alignment. Finally, it requires manual activation via a switch 104 on the body of the camera system 101, making it difficult to employ quickly when the operator is in a heightened stress situation.

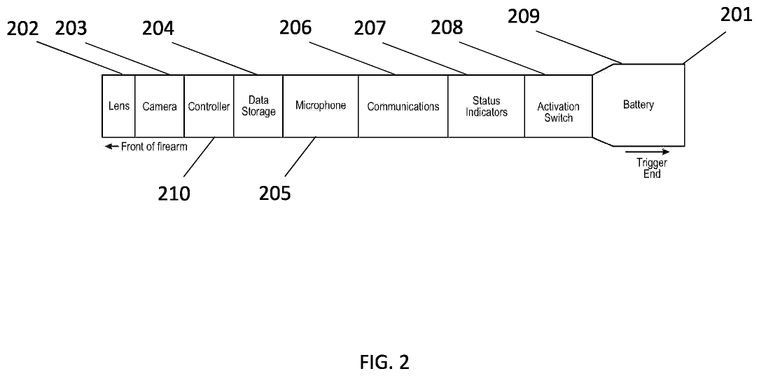

FIG. 2 illustrates a simple block diagram of the present invention embodied in the shape of a firearm guide rod 201. The camera lens 202 is at or near the muzzle end of the guide rod 201 such that it has an unobstructed view of the area directly in front of the firearm. The camera lens 202 could be optimized for various lighting conditions and fields of view, depending on what is required for the application. The camera 203 contains an image sensor (e.g., CCD or CMOS) that captures visual images and is mounted directly behind the camera lens 202. The controller 210 is shown directly behind the camera, but it could be located anywhere in the guide rod 201. The controller 210 performs numerous functions, such as reading image data from the camera, writing data to the data storage unit, transferring information to and from the communications interface, monitoring the state of charge and health of the battery unit, and controlling status indicators. The controller 210 may be a separate electronic component, such as a microcontroller, or it may be integrated with the camera 203, data storage unit 204, communications interface 206, or another electronics subsystem housed in the guide rod. While not shown explicitly, the controller 210 may have built-in program memory, or it may store and retrieve program memory from a separate non-volatile memory component, such as a an electrically erasable programmable read-only memory (EEPROM) or non-volatile static random-access memory (nvSRAM). The data storage unit 204 may be removable or non-removable and could be located anywhere in the guide rod. The data storage unit is used primarily to store video and audio data, although other data and information may be stored in the data storage unit. A microphone 205 could be located anywhere in the guide rod 201 and could be capable of capturing voice and other sounds in the immediate environment near the firearm. The microphone 205 could receive sound through either end of the guide rod 201 or through apertures in the body of the guide rod 201. A communications interface 206, if present, could be anywhere in the guide rod 201. One likely place for a wired communications interface 206 would be at or near the battery unit end of the guide rod 201. Alternatively, the guide rod 201 may be separable and contain the communications interface 206 and data storage unit 204 in the end of one portion of the separated rod. The communications interface 206 could also be a wireless interface, such as WiFi or Bluetooth. If wireless communications are used, the device may have an antenna that is internal or external to the guide rod 201. Status indicators 207, visual and audible, could indicate the operability of the device. For example, status indicators 207 could display battery health and charge level, whether the camera is recording, and the amount of memory remaining. The status indicators 207 could be at either end of the guide rod, or they could show or sound through one or more apertures in the body of the guide rod 201. The camera system may also have a speaker that would serve as part of the status indicators unit 207. An activation switch 208 may be completely contained within the guide rod 201, such a gravity switch (aka tilt-controlled or orientation-controlled switch), light sensor (e.g., photodiode, photoresistor, or other photosensitive device), or remote-controlled relay, or it may be incorporated into the firearm, such as in the grip, backstrap, magazine release, safety, trigger, takedown lever, or slide stop lever. If a gravity switch is used, it could energize the camera system when the firearm is leveled to within a predefined range of angles and deenergizes the camera system when outside those angles. Finally, the battery unit 209 is conceptually shown at the trigger end of the guide rod 201, but it could be anywhere in the guide rod. The battery unit 209 could also include a voltage converter to address differences between the battery voltage and the required electronics power supply levels. Access to the battery unit 209 could be through a removable end cap, a port on the guide rod, or by disassembly of the guide rod. The battery unit 209 could consist of rechargeable or one-time use disposable batteries, or a combination of the two. Also not shown, the camera system could contain voltage level translators required to interface between the camera 203, controller 210, data storage unit 204, status indicators 207, communications interface 206, and other electronics. Additionally, not explicitly shown is any power management circuitry used to optimize battery life while enabling rapid activation of the device.

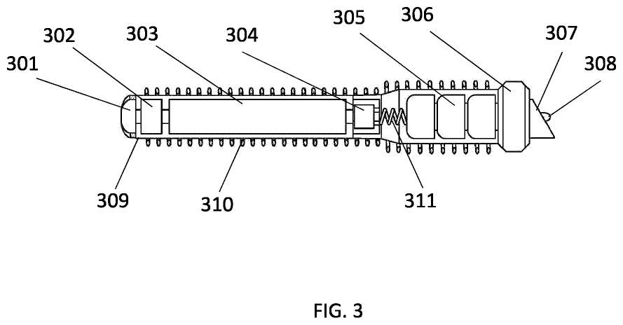

FIG. 3 illustrates a cutaway view of one embodiment of the present invention. The guide rod 309 is encircled by one or more recoil springs 310 to reduce recoil and return the firearm's slide to the ready position following a discharge. The camera lens 301 faces out the muzzle end of the firearm. The camera lens 301 is operatively coupled to the camera 302, which resides within the guide rod 309. In the body of the guide rod 309 is a circuit assembly 303, that contains the camera interface electronics, controller, data storage electronics, voltage level translators, voltage converters, power management circuitry, and communications electronics, if present. The battery unit, including batteries 305, are also contained within the guide rod. The activation switch 304 may also be contained in the guide rod, if not located elsewhere on the firearm. A simple spring connection 311 is shown in this embodiment as a method of connecting between the batteries 305 and the activation switch 304. Many other connections between the batteries and camera assembly are possible. Finally, an endcap 306, which may or may not be removable, seals the guide rod components. The endcap 306 could be a simple circular disk or something more tailored to fit the firearm, such as shown here. A guide rod end support 307 ensures that the guide rod 309 properly mates with the firearm, typically by interlocking the guide rod between the slide's barrel bushing and the barrel's recoil spring guide bushing. A compressible pin or other switch 308 may be used to determine when the guide rod 309 is properly interlocked with the firearm or to allow external on/off control using a switch lever, such as one integrated with the slide stop lever.

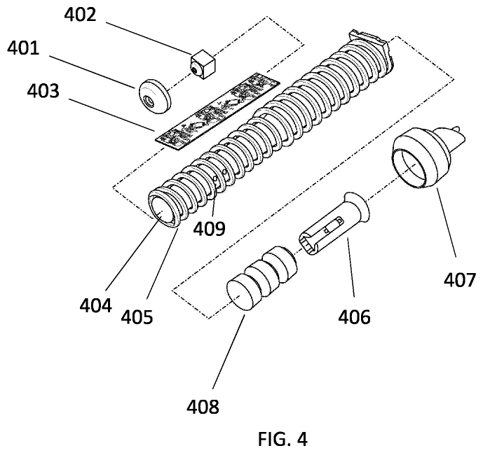

FIG. 4 illustrates an exploded view of one embodiment of the present invention. In this embodiment, the camera lens 401 is located at the muzzle end of the guide rod 404, with the camera 402 operatively coupled to the camera lens 401. The camera 402 is connected to the circuit assembly 403, fixed or flexible, including those associated with the camera interface electronics, controller, data storage, communications, microphone, speaker, status indicators, activation, voltage conversion, voltage level translation, power management circuitry, and communications interface electronics. In this particular embodiment, a wireless communications interface and a data storage unit are both contained in the circuit assembly 403. The antenna for the wireless communications interface is not shown but could be part of the circuit assembly 403 or mounted internal or external to the guide rod 404. In this embodiment, the batteries 408 are removable and located at the opposite end of the guide rod 404. They are enclosed in a battery unit housing 406 which is then secured into the endcap assembly 407. The guide rod 404 may be flared or enlarged anywhere along its length to accommodate the battery unit, the camera 402, the circuit assembly 403, and other components. Surrounding the guide rod 404 is a recoil spring 405 to reduce recoil and cause the firearm's slide to return to its ready position after the firearm is discharged. The endcap 407 secures the guide rod, typically by interlocking the guide rod between the slide's barrel bushing and the barrel's recoil spring guide bushing. The endcap 407 could be a simple circular disk or something more tailored to fit the firearm, such as shown here. The guide rod 404 may have apertures 409 to allow sound to enter or exit, or to allow visual status indicators to be viewed, such as when the firearm's slide was retracted.

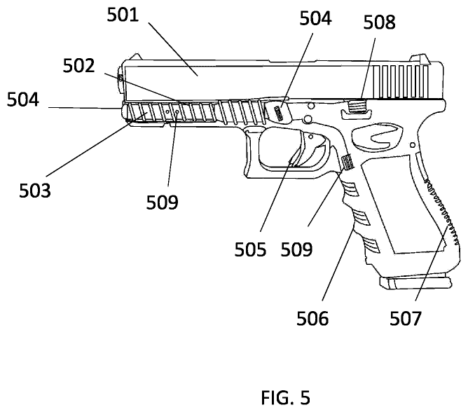

FIG. 5 illustrates a cutaway view of one embodiment of the present invention 503 embedded into a semi-automatic firearm 501. The invention 503 replaces the firearm's factory stock guide rod assembly and does not require that the firearm's frame be modified. Rather, the invention fits in place of the factory stock guide rod, typically between the slide's barrel bushing and the barrel's recoil spring guide bushing. The camera lens 504 faces out the muzzle end of the firearm 501. One or more springs 502 surround the guide rod to reduce recoil and ensure that the slide returns to its ready position following a discharge. Apertures 509 are present in the guide rod to allow light to emit from one or more internal status indicators, as well as for sound to enter or exit the guide rod. The activation switch may be internal to the new guide rod camera system 503, or integrated with the slide stop lever 508, takedown lever 504, trigger 505, safety lever (if firearm is equipped with such), grip 506, backstrap 507, or magazine release 509.

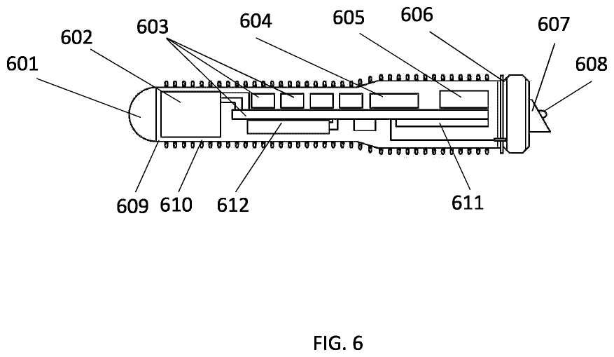

FIG. 6 illustrates a cutaway view of one embodiment of the present invention. The guide rod 609 is encircled by one or more springs 610 to reduce recoil and return the firearm's slide to the ready position following a discharge. The camera lens 601 faces out the muzzle end of the firearm. The camera lens 601 is operatively coupled to the camera 602, which resides within the guide rod 609. In the body of the guide rod 609 is a circuit assembly 603, which includes circuits associated with the camera interface electronics, controller, data storage, communications, microphone, speaker, status indicators, activation, voltage conversion, voltage level translation, power management circuitry, and communications electronics, if present. A battery unit 612 is also contained within the guide rod and attached to the circuit assembly 603. The battery unit 612 could also include a voltage converter to address differences between the battery voltage and the required electronics power supply levels. An orientation-controlled activation switch 604 is shown contained within the guide rod, but it, or another type of activation switch, could also be elsewhere on the firearm. A wired communications interface 605 is also operatively coupled to the circuit assembly 603. An example of a wired communications interface 605 might be a USB-C port. Likewise, a data storage unit 611 is also operatively coupled to the circuit assembly 603. An example of a data storage unit 611 might be a micro-SD slot with removable SD memory card. Both the communications interface 605 and data storage unit 611 are accessible by removing the endcap 606. The endcap 606 seals the guide rod components. A guide rod end support 607 ensures that the guide rod 609 properly mates with the firearm, typically by interlocking the guide rod between the slide's barrel bushing and the barrel's recoil spring guide bushing. A compressible pin or other switch 608 may be used to determine when the guide rod 609 is properly interlocked with the firearm or to allow external on/off control using a switch lever, such as one integrated with the slide stop lever.

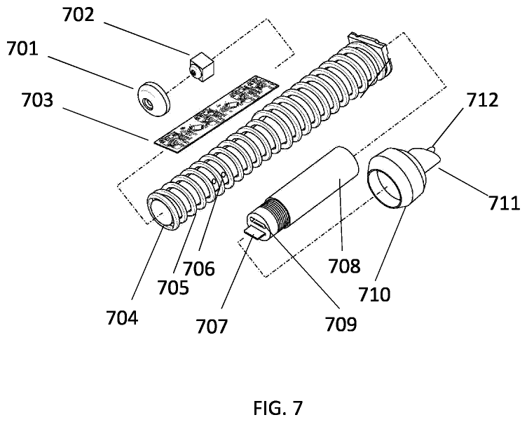

FIG. 7 illustrates an exploded view of one embodiment of the present invention. In this embodiment, the camera lens 701 is located at the muzzle end of the guide rod 704, with the camera 702 operatively coupled to the camera lens 701. The camera 702 is operatively coupled to the circuit assembly 703, fixed or flexible, including those associated with the camera interface electronics, controller, data storage, communications, microphone, speaker, status indicators, activation, voltage conversion, voltage level translation, and communications electronics, if present. In this embodiment, the battery unit is rechargeable and integrated with the circuit assembly 703. The guide rod 704 may be flared or enlarged anywhere along its length to accommodate the camera 702, controller, data storage unit 707, communications interface 709, and other components. Surrounding the guide rod 704 is a recoil spring 705 to reduce recoil and force the firearm's slide to its ready position after the firearm is discharged. The endcap 710 secures the guide rod components and ensures proper mating with the firearm. The guide rod 704 may have apertures 706 to allow sound to enter or exit, or to allow the status indicators to be viewed, such as when the firearm's slide is retracted. The data storage unit 707 and communications interface 709 may be secured in an interior housing 708 which is accessible by removing the endcap 710. The endcap 710 could be secured by threading, friction fit, magnetic attraction, latching, or other means. The guide rod end support 711, which may not always be required, extends from the endcap 710 to ensure proper mating with the firearm, typically by interlocking the guide rod between the slide's barrel bushing and the barrel's recoil spring guide bushing. A compressible pin or switch 712 is included in this embodiment to determine when the guide rod 704 and guide rod end support 711 are properly interlocked with the firearm or to allow external on and off control using a switch lever, such as one integrated with the slide stop lever.

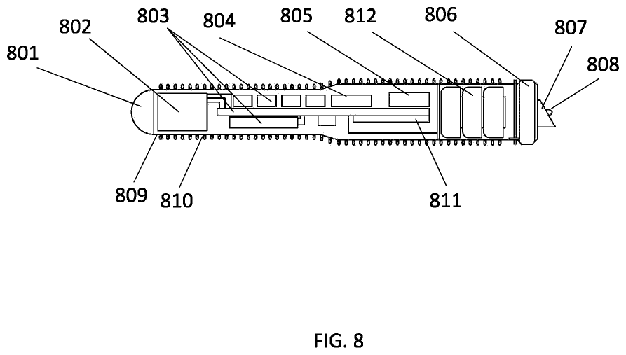

FIG. 8 illustrates a cutaway view of one embodiment of the present invention. The guide rod 809 is encircled by one or more springs 810 to reduce recoil and return the firearm's slide to the ready position following a discharge. The camera lens 801 faces out the muzzle end of the firearm. The camera lens 801 is operatively coupled to the camera 802, which resides within the guide rod 809. In the body of the guide rod 809 is a circuit assembly 803, which includes circuits associated with the camera interface electronics, controller, data storage, communications, microphone, speaker, status indicators, power management, activation, voltage conversion, voltage level translation, and communications electronics, if present. A battery unit 812 at the trigger end of the guide rod 809 contains one or more batteries that are attached to the circuit assembly 803. The battery unit 812 could also include voltage converters to address differences between the battery voltage and the required electronics power supply levels. An orientation-controlled activation switch 805 is shown contained within the guide rod 801, but it, or another type of activation switch, could also be elsewhere on the firearm. A wired communications interface 805 is also operatively coupled to the circuit assembly 803. An example of a wired communications interface 805 might be a USB-C port. Likewise, a data storage unit 811 is also operatively coupled to the circuit assembly 803. An example of a data storage unit 811 might be a micro or nano-SD socket with removable SD memory card. In this embodiment, both the communications interface 805 and data storage unit 811 are accessible by removing the endcap 806 and battery unit 812. The endcap 806 seals the guide rod components. A guide rod end support 807 ensures that the guide rod 809 properly mates with the firearm, typically by interlocking the guide rod between the slide's barrel bushing and the barrel's recoil spring guide bushing. A compressible pin or other switch 808 is shown in this embodiment to determine when the guide rod 809 is properly interlocked with the firearm or to allow external on/off control using a switch lever, such as one integrated with the slide stop lever.

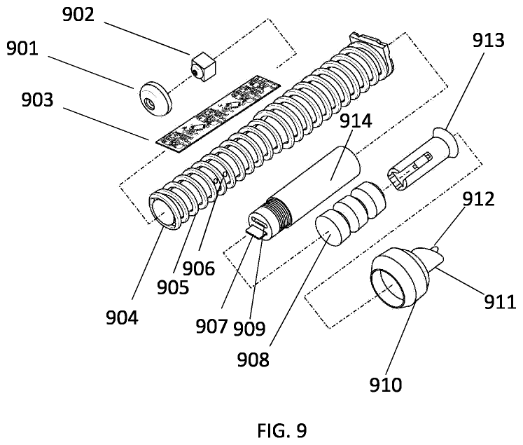

FIG. 9 illustrates an exploded view of one embodiment of the present invention. In this embodiment, the camera lens 901 is located at the muzzle end of the guide rod 904, with the camera 902 operatively coupled to the camera lens 901. The camera 902 is connected to the circuit assembly 903, fixed or flexible, which includes circuits associated with the camera interface electronics, controller, data storage, communications, microphone, speaker, status indicators, activation, voltage conversion, voltage level translation, power management, and communications electronics, if present. In this embodiment, the battery unit consists of removable batteries 908 and a battery unit housing 913. The guide rod 904 may be flared or enlarged anywhere along its length to accommodate the camera 902, data storage unit 907, communications interface 909, and other components. Surrounding the guide rod 904 is a recoil spring 905 to reduce recoil and force the firearm's slide to its ready position after the firearm is discharged. The endcap 910 secures the guide rod components and ensures proper mating with the firearm. The guide rod 904 may have apertures 906 to allow sound to enter or exit, or to allow the status indicators to be viewed, such as when the firearm's slide was retracted. The data storage unit 907 and communications interface 909 may be secured in an interior housing 914 and be accessible by removing the endcap 910 and battery unit 908, 913. The endcap 910 could be secured by threading, friction fit, magnetic attraction, latching, or other means. The guide rod end support 911 which may not always be required, extends from the endcap 910 to ensure proper mating with the firearm, typically by interlocking the guide rod between the slide's barrel bushing and the barrel's recoil spring guide bushing. A compressible pin or switch 912 is included to determine when the guide rod 904 is properly interlocked with the firearm or to allow external on/off control using a switch lever, such as one integrated with the slide stop lever.

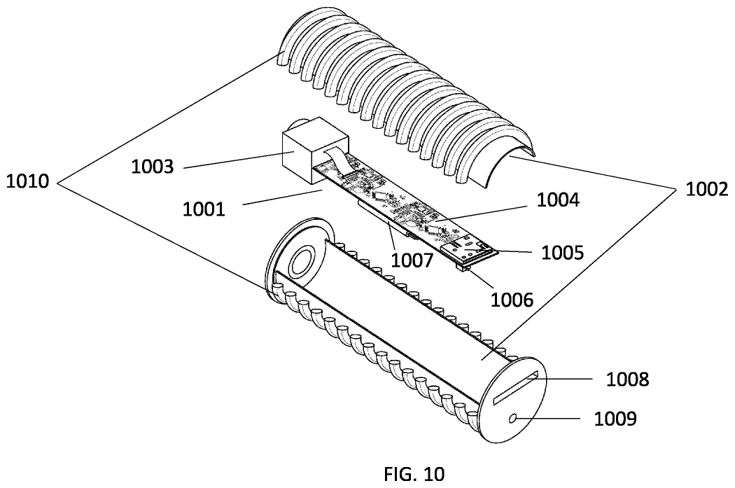

FIG. 10 illustrates an exploded view of one embodiment of the present invention. In this embodiment, the camera system 1001 is enclosed in a clamshell 1002. The camera and lens assembly 1003 are located at the muzzle end of the guide rod, with the camera operatively coupled to the camera lens. The camera is connected to the circuit assembly 1004. fixed or flexible, which includes circuits associated with the camera interface electronics, controller, data storage, communications, microphone, speaker, status indicators, activation, voltage conversion, voltage level translation, power management, and communications electronics, if present. In this embodiment, the battery unit 1007 consists of a non-removable rechargeable battery mounted to the circuit assembly 1004. In this embodiment, there is not a wired communications interface, but there could be a wireless communications interface, not explicitly shown. The data storage unit 1005 is accessible through a slot 1008 in one end of the guide rod 1002. The guide rod 1002 may be flared or enlarged anywhere along its length to accommodate the camera 1003, circuit assembly, data storage unit 1005, or other components. Surrounding the guide rod 1002 is a recoil spring 1010 to reduce recoil and force the firearm's slide to its ready position after the firearm is discharged. In this embodiment, the guide rod does not include an end support beyond a simple disk that mates with the firearm by interlocking the guide rod between the slide's barrel bushing and the barrel's recoil spring guide bushing. A compressible pin or switch 1006 is included to determine when the guide rod 1002 is properly interlocked with the firearm or to allow external on/off control using a switch lever, such as one integrated with the slide stop lever. The pin protrudes through a hole 1009 in the end of the guide rod.

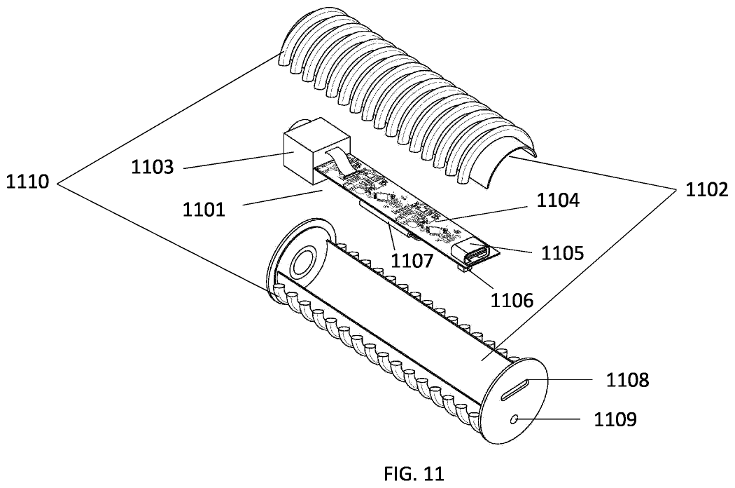

FIG. 11 illustrates an exploded view of one embodiment of the present invention. In this embodiment, the camera system 1101 is enclosed in a clamshell 1102. The camera and lens assembly 1103 are located at the muzzle end of the guide rod, with the camera operatively coupled to the camera lens. The camera is connected to the circuit assembly 1104. fixed or flexible, which includes circuits associated with the camera interface electronics, controller, data storage, communications, microphone, speaker, status indicators, activation, voltage conversion, voltage level translation, power management, and communications electronics, if present. In this embodiment, the battery unit 1107 consists of a non-removable rechargeable battery mounted to the circuit assembly 1104. In this embodiment, there is a wired communications interface 1105, that is accessible a slot 1108 in one end of the guide rod. In addition to the wired communications interface 1105, there could be a wireless communications interface, not shown. The data storage unit is non-removable and embedded into the circuit assembly 1104. The guide rod 1102 may be flared or enlarged anywhere along its length to accommodate the camera 1103, circuit assembly, data storage unit 1105, or other components. Surrounding the guide rod 1102 is a recoil spring 1110 to reduce recoil and force the firearm's slide to its ready position after the firearm is discharged. In this embodiment, the guide rod does not include an end support beyond a simple disk that mates with the firearm by interlocking the guide rod between the slide's barrel bushing and the barrel's recoil spring guide bushing. A compressible pin or switch 1106 is included to determine when the guide rod 1102 is properly interlocked with the firearm or to allow external on/off control using a switch lever, such as one integrated with the slide stop lever. The pin protrudes through a hole 1109 in the end of the guide rod.

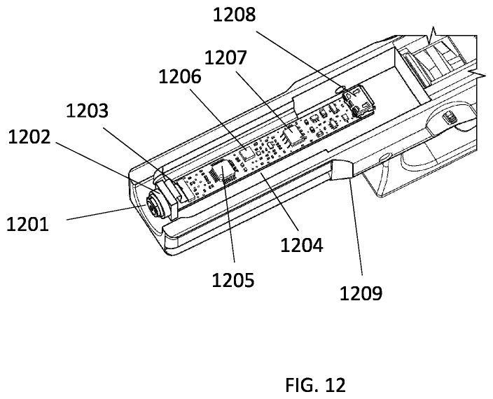

FIG. 12 illustrates a cutaway view of one embodiment of the present invention installed in the lower portion of a handgun 1209. The guide rod and recoil spring are not shown so that the internals of the invention are more easily seen. In this embodiment, the camera lens 1201 is nearly flush with the front of the firearm 1209. The camera 1202 is operatively coupled to the camera lens 1201, as well as attached to the circuit assembly 1204 using a miniature cable 1203. In this embodiment, the battery unit is attached to the underside of the circuit assembly 1204 and thus not visible. The circuit assembly also contains the controller 1205, memory for program software 1206, and a wireless communications interface 1207. At the trigger end of the circuit assembly is the data storage unit 1208, comprising an onboard socket and a removable flash memory card, and is accessible via a port in the trigger end of the guide rod.

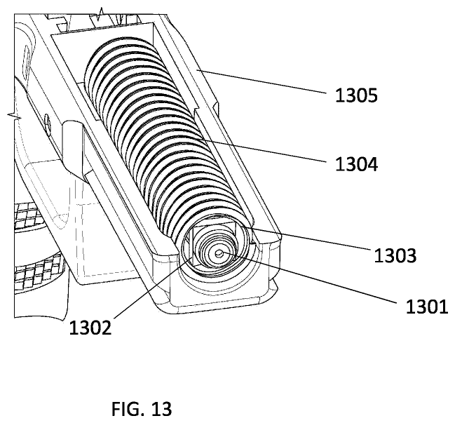

FIG. 13 illustrates a cutaway view of one embodiment of the present invention installed in the lower portion of a handgun 1305. The guide rod housing 1303 and recoil spring 1304 are shown in this illustration to better understand how the entire assembly might fit into a handgun. In this embodiment, the camera lens 1301 extends slightly beyond the front of the firearm 1305. The camera 1302 is operatively coupled to the camera lens 1301, and attached to the circuit assembly, which is enclosed by the guide rod housing 1303. The recoil spring 1304 circles the guide rod housing and acts to absorb recoil and return the slide to its starting position when the firearm is discharged. In this illustration, the circuit assembly, data storage unit, battery unit, communications interface, controller, and other components and assemblies are hidden by the guide rod housing 1303 and recoil spring 1304.

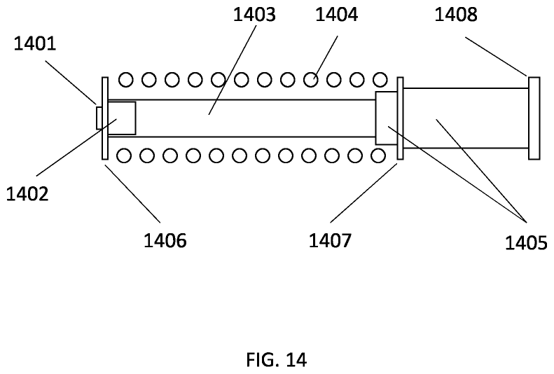

FIG. 14 illustrates a simplified cutaway view of a guide rod camera system with a multi-diameter housing and single spring on a portion of the guide rod. The camera lens 1401 is roughly aligned with the front of the firearm with the camera 1402 operably coupled to the camera lens 1401. The circuit assembly, not explicitly shown, is housed in the narrow portion of the guide rod 1403. This narrow portion of the guide rod 1403 is encircled by a recoil spring 1404, which is captured by the two spring supports 1406 1407. The left recoil spring support 1406 moves to the right when the slide is retracted, such as when the firearm is discharged. This compresses the recoil spring 1404 against the right recoil spring support 1407. Larger diameter sections of the guide rod 1405 house the communications interface, data storage unit, and battery unit, which may require additional volume. The guide rod end support 1408 interlocks the guide rod with the barrel's recoil spring guide bushing.

Automatic activation elements may be configured to automatically activate the system (e.g., begin the video capture and recording process) when an activation condition is met. Activation elements may have varying activation conditions. For example, the automatic activation element is an orientation sensor (e.g., a tilt sensor) and the system is automatically activated when the firearm is upright with its muzzle parallel to the ground. Alternatively, the automatic activation element is a light sensor (e.g., a photodiode, photoresistor, or other photosensitive device), and the system is automatically activated when the firearm is removed from its holster and exposed to a bright environment.

In some embodiments, the system does not include an activation element. Rather, video and/or audio is continuously recorded while the system has power. To minimize power consumption, video may be captured at a lower resolution or at a reduced framerate. To minimize memory requirements, the system may automatically record video in a continuous loop by overwriting the oldest footage with the newest footage once the storage capacity is reached. This ensures that the device can continue recording without user intervention to manually delete old files.

According to an embodiment, a firearm can be modified to include the system by removing a portion of the guide rod and replacing the removed portion with a housing where the housing secures the electrical components of the system. Preferably, the housing has the same shape as the removed portion of the guide rod. The removed portion of the guide rod can include the entire guide rod.

According to an embodiment, a firearm can be modified to include the system by creating a cavity in the guide rod (if the guide rod is not already hollow) and securing the electrical components system inside of the cavity. Preferably, the electrical components of the system are secured within a housing which itself is secured within the cavity.

The embedded guide rod camera system of this disclosure embodies a significant advancement over existing firearm camera systems that lack the ease-of-use, compactness, power efficiency, and durability of the present invention. Numerous embodiments have been discussed, with many more possible. Further, while the embodiments presented are focused on semi-automatic and automatic handgun applications, the invention could be readily applied to semi-automatic and automatic rifles and shotguns.

I claim:

1. A device to record video during handling of a firearm, the device comprising:
a camera configured to record video;
memory configured to store recorded video;
a control unit configured to control the device;
a battery configured to power the device;
wherein
the memory, control unit, and battery are secured within a cavity in a guide rod of the firearm;
the camera is positioned at a front end of the guide rod such that the recorded video depicts an environment in front of the firearm.

2. The device of claim 1, further comprising:
a wireless communication element configured to enable wireless communication with an external computing device associated with an owner of the firearm;
wherein
the wireless communication element is secured within the cavity.

3. The device of claim 1, further comprising:
a wired communication element configured to enable wired communication with an external computing device associated with an owner of the firearm;
wherein
the wired communication element is accessible through a port in the guide rod or the firearm.

4. The device of claim 3, wherein
the wired communication element is used to charge the battery.

5. The device of claim 1, further comprising:
a microphone configured to record audio;
wherein
the microphone is secured within the cavity; and
the memory is further configured to store recorded audio.

6. The device of claim 1, further comprising:
a status indicator configured to indicate a status of the device.

7. The device of claim 1, wherein
the memory is removable.

8. The device of claim 1, further comprising:
an activation element;
wherein
the device records video when an activation condition of the activation element is met.

9. The device of claim 8, wherein
the activation element is an orientation sensor; and
the activation condition is met when an orientation of the orientation sensor is within a range of preset orientations.

10. The device of claim 8, wherein
the activation element is a light sensor; and
the activation condition is met when light incident on the light sensor is within a range of preset brightnesses.

11. A device to record video during handling of a firearm, the device comprising:
a housing configured to replace a portion of a guide rod of the firearm, the housing having a shape of the replaced portion of the guide rod;
a camera configured to record video;
memory configured to store recorded video;
a control unit configured to control the device;
a battery configured to power the device;
wherein
the memory, control unit, and battery are secured within the housing or the firearm; and
the camera is positioned at a front end of the housing such that the recorded video depicts an environment in front of the firearm.

12. The device of claim 11, wherein
the memory, control unit, and battery are secured within the housing.

13. The device of claim 11, wherein
a wireless communication element configured to enable wireless communication with an external computing device associated with an owner of the firearm;
wherein
the wireless communication element is secured within the housing.

14. The device of claim 11, further comprising:
a wired communication element configured to enable wired communication with an external computing device associated with an owner of the firearm;
wherein
the wired communication element is accessible through a port in the housing or the firearm.

15. The device of claim 14, wherein
the wired communication element is used to charge the battery.

16. The device of claim 11, further comprising:
a microphone configured to record audio;
wherein
the microphone is secured within the housing; and
the memory is further configured to store recorded audio.

17. The device of claim 11, further comprising:
a status indicator configured to indicate a status of the device.

18. The device of claim 11, wherein
the memory is removable.

19. The device of claim 11, further comprising:
an activation element;
wherein
the device records video when an activation condition of the activation element is met.

20. The device of claim 19, wherein
the activation element is an orientation sensor; and
the activation condition is met when an orientation of the orientation sensor is within a range of preset orientations.

21. The device of claim 19, wherein
the activation element is a light sensor; and
the activation condition is met when light incident on the light sensor is within a range of preset brightnesses.

22. A device to record video during handling of a firearm, the device comprising:
a housing configured to replace a portion of a guide rod of the firearm, the housing having a shape of the replaced portion of the guide rod;
a camera configured to record video;
memory configured to store recorded video;
a control unit configured to control the device;
a battery configured to power the device;
a communication element configured to enable communication with an external computing device associated with an owner of the firearm;
wherein
the memory, control unit, communication element, and battery are secured within the housing;
the camera is positioned at a front end of the housing such that the recorded video depicts an environment in front of the firearm; and
the memory is removable.
